(19) United States
(12) Patent Application Publication
(10) Pub. No.: US 2026/0232032 A1
(43) Pub. Date: Aug. 13, 2026

(54) HEATING APPARATUS FOR AN AEROSOL GENERATING DEVICE

(71) Applicant: JT International SA, Geneva (CH)

(72) Inventor: Erik Snijder, Enschede (NL)

(73) Assignee: JT International SA, Geneva (CH)

(21) Appl. No.: 19/471,512

(22) PCT Filed: Apr. 2, 2024
(86) PCT No.: PCT/EP2024/058969

§ 371 Date: Oct. 1, 2025

(30) Foreign Application Priority Data
Apr. 5, 2023 (EP) 23166715.5

(51) Int. Cl. A24F 40/465; A24F 40/20

(52) U.S. Cl. CPC A24F 40/465; A24F 40/20

(57) ABSTRACT

A heating apparatus for an aerosol generating device including: an insulator including an inner wall and an outer wall, the inner wall defining a heating zone and including an opening through which an aerosol forming substance can be received in the heating zone, the outer wall positioned radially outwardly with respect to the inner wall; the insulator further including a welded bridge connecting the inner wall and the outer wall, wherein the welded bridge includes a groove; and a heating element arranged on the inner wall and configured to provide heat to a received aerosol forming substance.

### FIELD OF THE INVENTION

The present invention relates to a heating apparatus for an aerosol generating device and an aerosol generating device comprising a heating apparatus. The disclosure is particularly applicable to a portable aerosol generating device, which may be self-contained. In particular, the invention relates to an aerosol generating device with a heater disposed within a vacuum or insulator chamber.

### BACKGROUND

It is a developing field of interest to produce electronic cigarettes that heat, but do not burn, a solid or semi-solid aerosol forming substrate (typically known as a consumable) which comprises tobacco. These aerosol generating devices typically receive a consumable rod of tobacco in a heating chamber. The rod is heated to release aerosol which can be inhaled by a user. A common issue in these devices is that the heater which supplies heat to the heating chamber also undesirably heats the remainder of the device. In compact devices this can be especially disadvantageous because the temperature of the outer surfaces of the device, which are held by a user, can become unacceptably high.

In order to mitigate these effects some aerosol generating devices have been provided with vacuum chambers that can space the heater from the outer surfaces and provide thermal separation between the heating chamber and the outer surfaces held by a user. Within such aerosol generating devices, it is also desirable to improve the efficiency of the heating operation such that the battery life of the device may be extended. To this end, vacuum insulators have been implemented within aerosol generating devices in order to thermally insulate the cavity in which an aerosol substrate is heated, thereby limiting thermal losses to the external environment.

An object of the present invention is to further improve the heating efficiency and reduce undesired heat loss.

### SUMMARY OF INVENTION

According to an aspect of the invention, there is provided a heating apparatus for an aerosol generating device, comprising: an insulator comprising an inner wall and an outer wall, the inner wall defining a heating zone and comprising an opening through which an aerosol forming substance can be received in the heating zone, the outer wall positioned radially outwardly with respect to the inner wall; the insulator further comprising a welded bridge connecting the inner wall and the outer wall, wherein the welded bridge comprises a groove; and a heating element arranged on the inner wall and configured to provide heat to a received aerosol forming substance.

By reducing the amount of weld material connecting the inner and outer walls of the insulator the heating zone is better insulated. As will be appreciated, heat generated from the heating element is transferred to the inner wall and a received aerosol forming substance by thermal conduction. The heating zone can be considered as a cavity in which the aerosol forming substance can be received and heated by the heating element. Generated heat is insulated by the space between the outer wall and the inner wall, where the space may be a vacuum or filled with an insulating material. However, heat can travel from the inner wall to the outer wall by passing across the bridge, or welded bridge, connecting the two walls. To minimise and limit thermal conduction or heat loss from the inner wall/heating zone across the bridge, a groove is cut out from the welded bridge to reduce the material thickness of the bridge whilst maintaining the structural/physical integrity of the bridge (to enclose a vacuum for example).

In some embodiments the inner wall and the outer wall each comprises a metallic material, and a first end of the outer wall may be laser-welded to the bridge. In this way, both the inner wall and the outer wall may be made from a metallic material for ease of manufacturing. The inner wall may comprise a metallic material to improve thermal conduction from the heater to a received aerosol generating substance/consumable in the heating zone. Preferably, the bridge is laser-welded to the inner wall. In this way, a highly precise laser welding technique ensures that bond between the inner wall, the bridge and the outer wall can be made. Advantageously laser welding ensures a particularly effective bond between the welded surfaces, requiring a low surface area for bonding. Other welding techniques may also be employed, such as resistance welding.

The groove may be V-shaped or U-shaped or indeed any other shape according to manufacturing/design requirements. The groove may be cut into the welded bridge, preferably by grinding or machining or by another method in the art as will be understood by the skilled person. Importantly, the groove reduces the thickness of the welded bridge such that the reduced-thickness section of the bridge acts as a “thermal break” to significantly prevent undesirable heat loss (i.e. thermal conduction) away from the heating zone. As such, the present invention improves the effectiveness of a heating apparatus by reducing heat transport away from the inner wall to the outer wall and to the outside of an aerosol generating device.

The welded bridge may be a loop, preferably wherein the loop is ring-shaped. In this way, the bridge acts as a spacer between the inner and outer walls and can also enclose the insulation space in between the two walls. The ring-shaped loop ensures that the bridge encircles the inner wall and may fully join the inner wall to the outer wall.

Preferably, the welded bridge comprises a predetermined minimum thickness. It should be understood that the welded bridge must sufficiently connect to the respective inner and outer walls (at each end of the bridge) with surface areas that ensure adequate bonds are formed between the bridge and the walls. These surface areas are determined by the thickness of the bridge material (and the length of the bridge material along the respective inner and outer wall). However, the thickness of the bridge may be reduced away from the ends of the welded bridge (i.e. in the mid-section of the bridge), where a groove may be cut into the bridge mid-section. The minimum thickness may therefore be the thickness of the remaining material of the bridge mid-section where a groove has been cut into the bridge. For example, the minimum thickness of the welded bridge may be where an apex of a groove is in the bridge. A minimum thickness of this bridge mid-section/groove section of the bridge may be predetermined in order to ensure that the welded bridge is able to maintain structural integrity across the bridge component as well as provide an effective insulation space between the inner and outer walls, particularly when the inner and outer walls and the welded bridges enclose a vacuum or hold an insulating material which may leak or spill out of the space if it is not enclosed.

Preferably, the welded bridge comprises a filler material. In this way, the thickness of the welded bridge may be more easily controlled. Suitable filler materials and rods will be apparent to the person skilled in the art of welding thin-walled joints. Alternatively, the bridge may be welded by melting the inner and outer walls (i.e. the base materials) together without a filler material.

Preferably, a face of the outer wall is arranged by at least a predetermined distance away from a face of the inner wall. In this way, a sufficient length of the welded bridge can be provided to allow a groove to be cut into the bridge.

Preferably, a vacuum is enclosed between the inner wall and outer wall. Alternatively, the insulator may further comprise an insulating material between the inner wall and outer wall. For example, the first insulator may comprise an aerogel material between its inner and outer walls. Examples of insulating materials include, but are not limited to: air, aerogel materials, powders or fibrous insulating materials.

Preferably, the heating apparatus further comprises a heater cup, the heater cup comprising the inner wall and an end to limit a depth of insertion for the received aerosol forming substance. In this way the heater cup provides an end of the heating zone/cavity for a received aerosol forming consumable to abut against. In this way the heater may have a closed end such that there is a single opening for airflow and for insertion of the aerosol forming consumable. Alternatively, the end may further include one or more holes to enable airflow into the heating zone/cavity.

Preferably, the heating apparatus further comprises a heater sleeve, the heater sleeve comprising the inner wall. In these arrangements the welded bridge can connect a first end of the inner wall with a first end of the outer wall a second welded bridge may be used to connect a second end of the inner wall with a second end of the outer wall. In this way, welded bridges are provided at each end of the heater sleeve to limit thermal conduction away from the inner wall / heater sleeve. A heater sleeve allows airflow through the sleeve such that generated aerosol can be carried by an airflow to the user on inhalation.

Preferably, the heating element is provided between the inner wall and the outer wall. The heating apparatus may further comprise an electrical insulation layer provided between the heater and the inner wall. In this way, the safety of the device may be increased, as electrical conduction to other components of the heating apparatus or the aerosol generating device may be avoided. The electrical insulation layer could be provided as a layer of material deposited on the internal wall. Alternatively, the layer could be provided as a partial or full coating on the heater.

Preferably, the heating element comprises an electrically resistive track that is printed or coated on or wrapped around the inner wall. In this way, the heating element can effectively transfer heat to an aerosol generating substance received in the inner wall by thermal conduction. A printed or coated heating element can also ensure a reliable electrical contact with the inner wall. Moreover, the ease of manufacturing may be further improved. Alternatively, the heating element may comprise a separate heater track, such as a thin film heater, that is wrapped around the inner wall. To put it in another way, the heating element may comprise a thin film heater having an electrically conductive metallic track that is interposed between insulating layers, such as polyimide films. Alternatively, the heating element may comprise an induction heater powered by a coil arranged in the insulator.

Preferably, the heating apparatus further comprises one or more wires configured to connect the heating element to a power source that can supply electrical power to the heating element. The one or more wires may be positioned through one or more gaps in an outer wall/cup. The wires can have a lower mass, which can be advantageous in terms of carrying weight for the user as well as for reducing the thermal mass of the device.

This configuration can be simple to manufacture, thereby potentially reducing production costs. In one example, the wires have a single point of contact with the insulator. One or more seals may be provided around the wires to seal the one or more gaps and configured to prevent air from entering the insulation space between the inner wall and the outer wall and to hold the wires in place.

Preferably, the heating apparatus further comprises a thermocouple cable and/or thermistor wire configured to connect the heating element to a control circuit. In this way, the temperature of the heating element can be monitored and/or controlled by a control circuit.

According to another aspect of the invention there is provided an aerosol generating device configured to generate an aerosol for inhalation by a user, the aerosol generating device comprising the heating apparatus according the first aspect.

According to another aspect of the invention there is provided a method of manufacturing the heating apparatus according the first aspect, the method comprising the steps of: providing an inner wall to define a heating zone, the inner wall comprising an opening through which an aerosol forming substance can be received in the heating zone; arranging a heating element on the inner wall, the heating element configured to provide heat to the received aerosol forming substance; providing an outer wall radially outwardly with respect to the inner wall; welding a bridge to connect the inner wall to the outer wall to enclose the inner wall and the outer wall; and cutting a groove into the bridge.

### BRIEF DESCRIPTION OF DRAWINGS

Embodiments of the invention are now described, by way of example, with reference to the drawings, in which:

FIG. 1 is a perspective view of an aerosol generating device comprising a heating apparatus according to an embodiment of the invention;

FIGS. 2A and 2B are cross-sectional views of a heating apparatus according to an embodiment of the invention;

FIG. 3 is a cross-sectional schematic view of a heating apparatus according to another embodiment of the invention; and

FIG. 4 is a cross-sectional schematic view of another heating apparatus according to another embodiment of the invention.

### DETAILED DESCRIPTION

As described herein, a vapour is generally understood to refer to a substance in the gas phase at a temperature lower than its critical temperature, which means that the vapour can be condensed to a liquid by increasing its pressure without reducing the temperature, whereas an aerosol is a suspension of fine solid particles or liquid droplets, in air or another gas. It should, however, be noted that the terms ‘aerosol’ and ‘vapour’ may be used interchangeably in this specification, particularly with regard to the form of the inhalable medium that is generated for inhalation by a user.

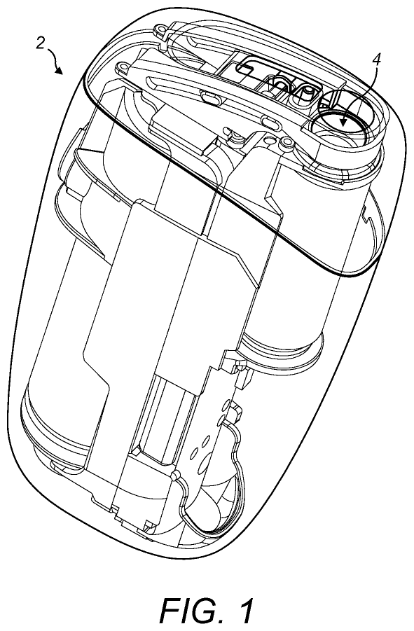

FIG. 1 illustrates an aerosol generating device 2 according to an embodiment of the invention. The aerosol generating device 2 is illustrated in an assembled configuration with exemplary internal components visible. The aerosol generating device 2 is a heat-not-burn device, which may also be referred to as a tobacco-vapour device, and comprises a heating apparatus 4 configured to receive an aerosol substrate such as a rod of aerosol generating material, e.g. tobacco. The aerosol generating device 2 may comprise a power source such as a battery and control circuitry for controlling the supply of power from the power source to the heating apparatus 4. The heating apparatus 4 is operable to heat, but not burn, the rod of aerosol generating material to produce a vapour or aerosol for inhalation by a user. Of course, the skilled person will appreciate that the aerosol generating device 2 depicted in FIG. 1 is simply an exemplary aerosol generating device according to the invention. Other types and configurations of tobacco-vapour products, vaporisers, or electronic cigarettes may also be used as the aerosol generating device according to the invention.

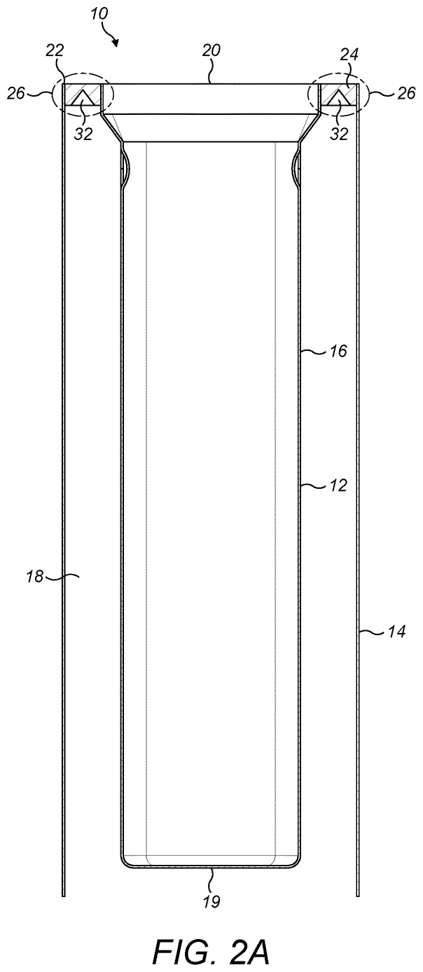

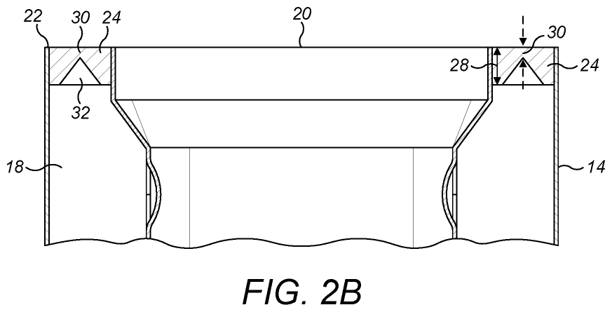

FIG. 2A shows a schematic view of a heating apparatus 10 having a heater cup 12 and an outer wall 14. An insulator of the heating apparatus 10 is provided by a wall 16 of the heater cup 12, which acts as the inner wall of the insulator, and the outer wall 14 is the outer wall of the insulator. The heater cup wall 16 is set apart from the outer wall 14 to provide an insulating space 18, which may a vacuum or filled with an insulating material such as air or an aerogel or fibrous insulating material. The skilled person will understand that the term “vacuum” refers to a space in which the pressure is considerably lower than atmospheric pressure due to the removal of free matter, in particular air. The quality of the vacuum formed between the inner wall 16 and the outer wall 14 may be a low vacuum, a medium vacuum, or a high vacuum.

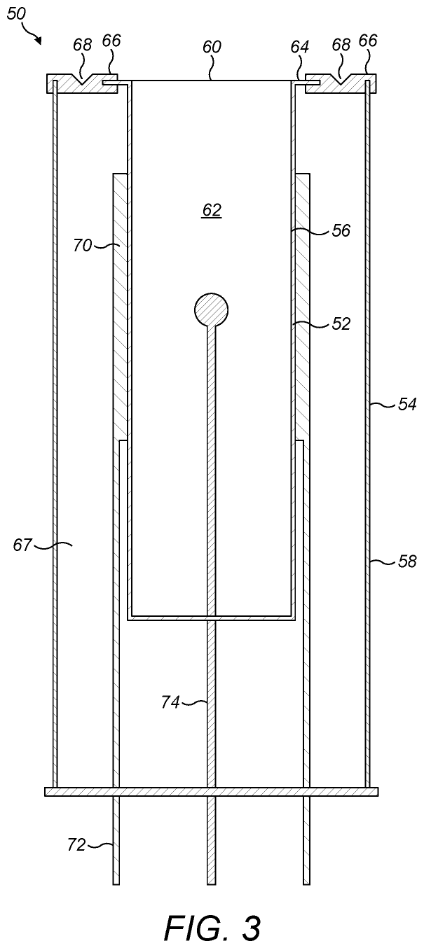

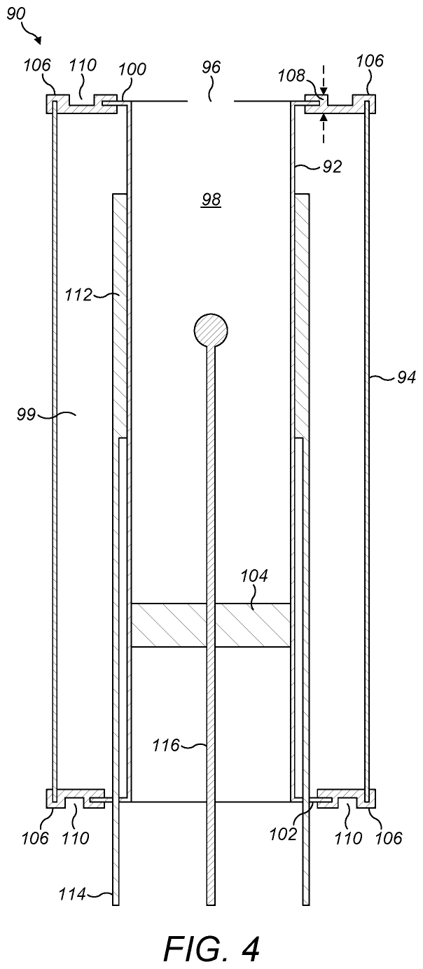

The heater cup 12 is closed at its base end 19, away from the open end 20 of the heater cup 12, to limit the depth of insertion of a consumable. In this example, the outer wall 14 has an open end 22, through which the heater cup 12 is received. The outer wall 14 may be part of a cup or a sleeve as will be explained in reference to FIGS. 3 and 4. As such the heater cup 12 is positioned radially within the inner surface of the outer wall 14.

The heater cup 12 and the outer wall 14 may be substantially cylindrical in shape, such that if viewed from above or below, i.e. parallel to a longitudinal axis of the heater cup 12 and the outer wall 14, the heater cup 12 and outer wall 14 appear as concentric circles (not shown). In alternative examples, the heater cup 12 and/or the outer wall 14 may be formed in other types of cross-sectional shape, such as a square or polygonal. As can be seen in FIGS. 2A and 2B, the open end 20 of the heater cup 12 may have a greater circumference or perimeter than the inner wall 16 (i.e. wall of the heater cup), and a tapered conical section between the wall 16 and the open end 20. This is to improve the ease of insertion of a consumable/aerosol forming substance (not shown) into the cavity/heating zone of the heating apparatus 10. In another example, a heater cup and the inner wall of the insulator may be separate components, where the heater cup is received into the cavity defined by the inner wall.

The open end 20 of the heater cup 12 is connected to open end 22 of the outer wall 14 by welding a bridge 24 between the two open ends. The bridge 24 may be formed using the material of the inner wall 16 and the outer wall 14, or alternatively a weld filler material may be used. As will be understood, the inner wall 16 and the outer wall 14 may each comprise a metallic material which can be welded together or to a separate bridge material, or alternatively, the walls may comprise a glass material which is laser welded to a bridge material. The bridge 24 connection encloses the space 18 between the inner and outer walls, which may comprise a vacuum or be filled with an insulating material. Accordingly, the bridge 24 surrounds, or encircles, the open end 20 of the heater cup 12 and has a loop or ring shape.

An exploded view of top end of the heating apparatus 10 and the bridge connections, depicted by the oval shapes 26 in FIG. 2A, is shown in FIG. 2B. As can be seen, the bridge 24 has a thickness 28 in the longitudinal direction of the heating apparatus 10 so as to provide the structural integrity to contain a vacuum or insulating material. For example, the ends of the bridge 24 should be sufficiently bonded or welded to the respective inner or outer wall. In other words, the bridge 24 (which can also be called a weld ring or a connecting ring) must have a sufficient thickness to ensure that enough surface area is available for welding the inner wall and outer wall with the bridge 24. In addition, the bridge 24 must be thick enough to prevent itself from collapsing, for example under a vacuum pressure.

It has been found that the thickness 28 of the bridge 24 can be reduced to a predetermined minimum thickness 30 to decrease the amount of thermally conductive weld material/bridge material whilst maintaining the structural and physical integrity of the bridge 24. As will be appreciated by the skilled person, the predetermined minimum thickness 30 of the bridge 24 may be different depending on the quality of the vacuum or the insulating material provided between the inner wall 16 and the outer wall 14. The predetermined minimum thickness 30 of the bridge 24 may also depend on the material of the bridge 24.

In order to reduce the bridge thickness 28 to the predetermined minimum thickness 30, a groove 32 is cut into the bridge 24 material. This may be performed by grinding or cutting, or another machining method in the art. As can be seen in FIG. 2B, a V-shaped groove 32 is cut into the lower surface of the bridge 24. However, any shape of groove 32 may be used and the groove 32 may be cut into the upper surface of the bridge 24 as is required by design or manufacturing processes. In another example, grooves may be cut into both the upper and lower surfaces of the bridge 24 to obtain the predetermined minimum thickness 30. Importantly, the amount of material of the bridge 24 is reduced to a minimum thickness along the length of the bridge 24 between the inner wall 16 and the outer wall 14 so as to introduce a thermal break to heat loss or transfer away from the heater cup 12/heating zone of the heating apparatus 10.

FIG. 3 shows a schematic view of a heating apparatus 50 having an inner cup 52 and an outer cup 54. The heating apparatus 50 comprises an insulator which includes an inner wall 56 and an outer wall 58, which are the respective walls of the inner cup 52 and the outer cup 54. The inner wall 56 also defines an opening 60 through which an aerosol forming substance, or consumable, can be received in a heating zone 62 of the heating apparatus 50. The inner cup 52 comprises a metallic material, such as stainless steel, which has good thermal conduction properties. The opening 60 acts as the access point for insertion of a consumable into the heating apparatus 50 in its constructed form. The inner cup 52 is closed at its base to limit the depth of insertion of a consumable. The outer cup 54 comprises a metallic material, such as steel or stainless steel, and also has a closed end. The inner cup 52 and the outer cup 54 may also be formed from other materials, such as glass.

The inner cup 52 is positioned radially within the inner surface of the outer cup 54. The inner cup 52 and/or outer cup 54 may have circular cross-sections or be formed in other types of cross-sectional shape, such as a square or polygonal.

In this example the inner cup 52 has a lip 64 at its open end. The lip 64 points outwardly toward the outer cup 54. It should be understood that the lip 64 is an optional feature and may be removed as required by design or manufacturing limits.

The heating apparatus 50 further includes a bridge 66 as a welded connection between the inner cup 52 and the outer cup 54. Accordingly, the bridge 66 surrounds the open end of the inner cup 52 with a loop or ring shape, and encloses an insulation space 67 between the outer surface of the inner cup 52 and the inner surface of the outer cup 54 to provide the insulator. The space 67 may be filled with a vacuum or another insulating material.

As described above with reference to FIGS. 2A and 2B, the bridge 66 may be formed using the material of the inner cup 52 and the outer cup 54, or by using a weld filler material. The bridge 66 has a thickness in the longitudinal direction of the heating apparatus 50 to provide the structural integrity and maintain an effective bond with the respective inner and outer cups.

The bridge 66 includes a groove 68 that is cut into the bridge 66 material, which reduces the thickness of the bridge 66 at the groove 68. This may be performed by grinding or cutting, or another machining method in the art. As can be seen in FIG. 3, a V-shaped groove 68 is cut into the upper surface of the bridge 66 to provide a predetermined minimum thickness of the bridge material at the apex of the groove 68. However, any shape of groove may be used and the groove may be cut into the upper surface of the bridge according to design or manufacturing processes. The amount of material of the bridge 66 is thus reduced to the predetermined minimum thickness along the length of the bridge 66 at the apex of the groove between the inner wall 56 and the outer wall 58 to provide a thermal break to heat loss or transfer away from the inner cup 52/heating zone 62 of the heating apparatus 50.

In FIG. 3, a heater 70 is provided on the outer surface of the inner cup 52 (i.e. such that the heater is provided in the insulation space 67). The heater 70 is an electrically resistive track that may be printed or coated on the inner cup 52. Alternatively, the heater 70 may be layered on the inner cup 52. Electrical wires 72 connects the heater 70 to a power source or a printed circuit board assembly, PCBA (not shown). The heating apparatus 50 also optionally comprises a thermocouple or thermistor wire 74 which is connected to the PCBA to monitor and/or control the temperature of the heater 70. The electrical wires 72 and the thermocouple/thermistor wire 74 may pass through holes in the base of the outer cup 54 (which can then be suitably sealed). Alternatively, if the outer cup comprises a glass material, the wires may be moulded into the base end.

FIG. 4 shows another schematic view of a heating apparatus 90 having an inner sleeve 92 and an outer sleeve 94. The inner sleeve 92 comprises the inner wall of the heating apparatus 90, which defines an opening 96 through which a consumable, can be received in a heating zone 98 of the heating apparatus 90. The opening 96 acts as the access point for insertion of a consumable into the heating apparatus 90 in its constructed form, and the inner sleeve 92 comprises a metallic material which has good thermal conduction properties.

The outer sleeve 94 comprises the outer wall of the heating apparatus 90 and may be made of a metallic material, such as steel or stainless steel, which is readily formed into a tube or cylindrical shape. The inner sleeve 92 is positioned radially within the inner surface of the outer sleeve 94. The insulator of the heating apparatus 90 comprises a space 99 between inner sleeve 92 and the outer sleeve 94, in which a vacuum or insulating material is provided. The inner and outer sleeves may comprise another material, other than a metallic material, such as glass.

The inner sleeve 92 has a top lip 100 and a bottom lip 102 at the top and bottom ends of the inner sleeve 92 respectively. The top and bottom lips 100, 102 point outwardly toward the outer sleeve 94. As described in reference to FIG. 3, the lips of the inner sleeve 92 are an optional feature.

The inner sleeve 92 further optionally comprises a plug 104 positioned within the inner sleeve 92 to act as an abutment for an inserted consumable. The plug 104 may be ring-shaped or have apertures to allow airflow across the plug 104, or alternatively may be a solid block to prevent airflow.

The heating apparatus 90 further includes bridges 106 welded between the inner and outer sleeves at the upper and lower ends of the sleeves. Accordingly, the bridges 106 surrounds the open ends of the inner sleeve 92 with a respective loop or ring shape, and encloses the space 99 between the outer surface of the inner sleeve 92 and the inner surface of the outer sleeve 94. As described above with reference to FIGS. 2 and 3, the bridge 106 may be formed using the material of the sleeves, or by using a weld filler material.

Each bridge 106 has a thickness 108 in the longitudinal direction of the heating apparatus 90 to provide the structural integrity and maintain an effective bond with the respective inner and outer sleeves. Each bridge 106 also includes a groove 110 that is cut into the bridge 106 material, which reduces the thickness of the bridge 106 at the groove 108.

As can be seen in FIG. 4, U-shaped grooves 108 are cut into the outer surface of the bridges 106 to provide a predetermined minimum thickness of the bridge material. However, any shape of groove may be used and the groove may be cut into any surface of the bridge according to design or manufacturing processes. The amount of material of the bridge 106 is thus reduced to the predetermined minimum thickness along the length of the bridge 106 between the inner sleeve 92 and the outer sleeve 94 to provide a thermal break to heat loss or transfer away from the heating zone 98 of the heating apparatus 90.

The heating apparatus 90 includes a heater or heating element 112, electrical wires 114, and a thermistor wire 116 similar to those described with reference to the above heating apparatus 50 of FIG. 3. The heating element 112 is provided on the outer surface of the inner sleeve 92 in the insulating space 99 (between the inner and outer sleeves). The heating element may be an electrically resistive track that may be printed or coated on the inner sleeve 92. Alternatively, the heater 112 may be layered on the inner sleeve 92.

The electrical wires 114 connect the heating element 112 to a power source or a PCBA (not shown). The thermocouple or thermistor wire 116 is connected to the PCBA to monitor and/or control the temperature of the heating element 112. In this example, the electrical wires 114 pass through the bottom lip 102 of the inner sleeve 92 away from the lower welded bridges 110. However other designs and arrangements of the electrical wires 114 in the heating apparatus 90 will be apparent to the skilled person. The thermocouple/thermistor wire 116 may pass through a hole in the plug 104 which can then be suitably sealed. Alternatively, if the plug 104 comprises a glass material, the thermistor wire 116 may be moulded into the plug 104.

1. A heating apparatus for an aerosol generating device, comprising:
an insulator comprising an inner wall and an outer wall, the inner wall defining a heating zone and comprising an opening through which an aerosol forming substance can be received in the heating zone, the outer wall positioned radially outwardly with respect to the inner wall;
the insulator further comprising a welded bridge connecting the inner wall and the outer wall, wherein the welded bridge comprises a groove; and
a heating element arranged on the inner wall and configured to provide heat to a received aerosol forming substance.

2. The heating apparatus of claim 1, wherein the welded bridge is a loop.

3. The heating apparatus of claim 1, wherein the welded bridge comprises a predetermined minimum thickness.

4. The heating apparatus of claim 1, wherein the welded bridge comprises a filler material.

5. The heating apparatus of claim 1, wherein a face of the outer wall is arranged by at least a predetermined distance away from a face of the inner wall.

6. The heating apparatus of claim 1, wherein a vacuum is enclosed between the inner wall and outer wall.

7. The heating apparatus of claim 1, wherein the insulator further comprises an insulating material between the inner wall and outer wall.

8. The heating apparatus of claim 1, further comprising a heater cup, the heater cup comprising the inner wall and an end to limit a depth of insertion for the received aerosol forming substance.

9. The heating apparatus of claim 1, further comprising a heater sleeve, the heater sleeve comprising the inner wall.

10. The heating apparatus of claim 1, wherein the heating element is provided between the inner wall and the outer wall.

11. The heating apparatus of claim 1, wherein the heating element comprises an electrically resistive track that is printed or coated on or wrapped around the inner wall.

12. The heating apparatus of claim 1, further comprising one or more wires configured to connect the heating element to a power source configured to supply electrical power to the heating element.

13. The heating apparatus of claim 1, further comprising a thermocouple cable and/or thermistor wire configured to connect the heating element to a control circuit.

14. An aerosol generating device configured to generate an aerosol for inhalation by a user, the aerosol generating device comprising the heating apparatus according to claim 1.

15. A method of manufacturing a heating apparatus for an aerosol generating device, the method comprising the steps of:
providing an inner wall to define a heating zone, the inner wall comprising an opening through which an aerosol forming substance can be received in the heating zone;
arranging a heating element on the inner wall, the heating element configured to provide heat to the received aerosol forming substance;
providing an outer wall radially outwardly with respect to the inner wall;
welding a bridge to connect the inner wall to the outer wall; and
cutting a groove into the bridge.

16. The method of claim 15, wherein the welded bridge encloses the inner wall and the outer wall.

17. The method of claim 15, wherein the heating element is an induction heater powered by a coil arranged in the insulator, or an electrically resistive track.

18. The heating apparatus of claim 2, wherein the loop is ring-shaped.

19. A heating apparatus for an aerosol generating device, comprising:
an insulator comprising an inner wall and an outer wall, the inner wall defining a heating zone and comprising an opening through which an aerosol forming substance can be received in the heating zone, the outer wall positioned radially outwardly with respect to the inner wall;
the insulator further comprising a welded bridge connecting the inner wall and the outer wall, wherein the welded bridge comprises a groove; and
a heater arranged on the inner wall and configured to provide heat to a received aerosol forming substance
wherein the heater is:
an induction heater powered by a coil arranged in the insulator, or
an electrically resistive track.
